(19) United States
(12) Patent Application Publication
(10) Pub. No.: US 2014/0095319 A1
(43) Pub. Date: Apr. 3, 2014

(54) Text-Based Communication Services Based On User-Specified Privacy Settings

(71) Applicants: Glenn R. Bruns, Naperville, IL (US); Lalita Jagadeesan, Naperville, IL (US); Vladimir Kolesnikov, Jersey City, NJ (US)

(72) Inventors: Glenn R. Bruns, Naperville, IL (US); Lalita Jagadeesan, Naperville, IL (US); Vladimir Kolesnikov, Jersey City, NJ (US)

(21) Appl. No.: 13/631,234

(22) Filed: Sep. 28, 2012

(51) Int. Cl. G06F 21/00; G06Q 30/00; G06Q 30/02; H04L 29/06

(52) U.S. Cl. 705/14.66; 726/26; 705/400

(57) ABSTRACT

A text-based communication service executes a collaborative data security protocol and/or pricing of services based at least in part on a user-specified privacy policy. The user-specified privacy policy may dictate, for example, a manner of filtering or encryption of user text and may be implemented in text-based communication services including, without limitation, webmail, social networking, web search and Instant Messaging services.

### FIELD OF THE INVENTION

This invention relates generally to communications systems and, more particularly, to techniques for enhancing text-based communications services based at least in part on user-specified privacy settings.

### BACKGROUND OF THE INVENTION

Communication systems are well known in which users may provide content to various service platforms to execute certain communications services. Generally, users can contribute text content to service platforms residing in any type of network or hybrid network coincident to services such as web-based email, or “webmail” services (e.g., Gmail, Hotmail); social networking services (e.g., Facebook, LinkedIn, Twitter), web search services (e.g., Google, Bing) and Instant Messaging services, to name a few. Generally, any of these services involve one or more communication transactions between a user platform and service provider platform in which a user provides text content and the service platform processes the text content in some manner to execute a particular service. Such services are defined herein as text-based communication services.

One of the most common concerns associated with text-based communication services is the issue of data privacy. Privacy concerns include, for example, the fear that user-provided content can be stored or viewed by third parties without consent, or that content may be collected and/or combined to create profiles on individuals. Privacy policies may vary depending on the type of service and/or service agreements managed by respective service providers, from relatively little or no privacy to full privacy, typically as a function of price.

For example and without limitation, webmail service providers often provide free or low-cost email to users by subsidizing the cost of service with targeted advertising, wherein the targeted advertising is made possible by scanning user emails to extract user information and create user profiles based on the extracted information. In such service, the amount, nature and use of the extracted information is generally established and enforced under terms of service provider policy settings. To the extent alternative webmail service offerings may exist (i.e., without targeted advertisements, or generally having more comprehensive privacy policies), in practical effect the user's desired level of privacy (or pricing) may not be available, because services are established and enforced under unilateral control of the service provider. The same holds generally for any text-based communication service in which availability and enforcement of privacy settings, pricing or other service features is under unilateral control of the service provider.

### SUMMARY OF THE INVENTION

This problem is addressed and a technical advance is achieved in the art by providing techniques for enhancing text-based communications services based on user-specified privacy policy settings. In one example, embodiments herein describe a collaborative data security protocol and/or pricing of services based at least in part on a user-specified privacy policy. The user-specified privacy policy may dictate, for example, a manner of filtering or encryption of user text and may be implemented in text-based communication services including, without limitation, webmail, social networking and web search services.

Embodiments herein provide methods and apparatuses for providing a text-based communication service, in accordance with a communication system including a user platform operably connected to a service platform. In one embodiment, the service platform receives text content from the user platform, filters the text content according to a user-specified privacy policy and performs at least one service feature using the filtered text content. In another embodiment, the service platform receives filtered text content from the user platform, the filtered text content having been filtered from original text content according to a user-specified privacy policy, and performs at least one service feature using the filtered text content. In still another embodiment, the service platform receives filtered text content from the user platform, the filtered text content having been filtered from original text content according to a user-specified privacy policy, performs one or more service features using the filtered text content, receives indicia of the user-specified privacy policy and performs one or more service features based on the user-specified privacy policy. In still another embodiment, the service platform receives, from the user platform, indicia of one or more user-selected privacy policy settings, defining a user-specified privacy policy, prices at least one aspect of the text-based communication service based on the user-specified privacy policy and executes the at least one aspect of the text-based communication service based on the user-specified privacy policy.

### BRIEF DESCRIPTION OF THE DRAWINGS

The foregoing and other advantages of the invention will become apparent upon reading the following detailed description and upon reference to the drawings in which:

FIG. 1 is a block diagram of a communication system implementing a collaborative data security protocol based in part on user-specified privacy settings according to embodiments of the present invention;

FIG. 2 depicts a first exemplary embodiment of a collaborative data security protocol that may be used in the system of FIG. 1;

FIG. 3 depicts a second exemplary embodiment of a collaborative data security protocol that may be used in the system of FIG. 1; and

FIG. 4 depicts a third exemplary embodiment of a collaborative data security protocol that may be used in the system of FIG. 1.

### DESCRIPTION OF THE PREFERRED EMBODIMENT(S)

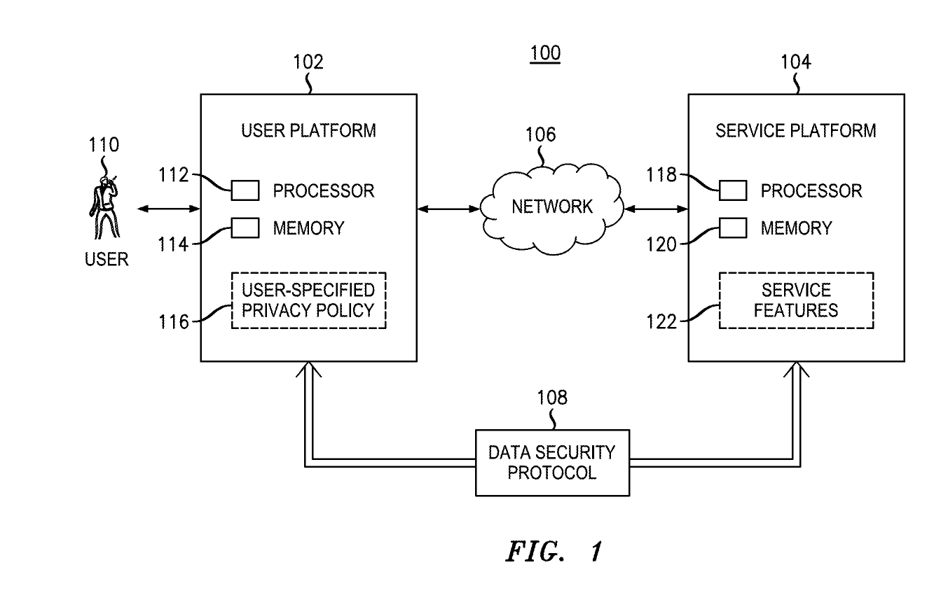

FIG. 1 illustrates a communication system 100 according to embodiments of the present invention. The communication system 100 includes one or more user platforms 102 (one shown) interconnected by a communication network 106 to a service platform 104.

The user platforms 102 may comprise, for example and without limitation, laptop computers, desktop computers or mobile computing devices that are subject to operation by users 110 (i.e., persons) to interact with the service platform 104 to execute a text-based communication service. The user platforms 102 are functional elements that may reside within one or more physical devices. The text-based communication service may comprise, for example and without limitation, a webmail, social networking or web search service, Instant Messaging service or generally any service in which users provide text content via respective user platforms and the service platform processes the text content in some manner to execute a particular service.

The service platform 104 comprises generally any server, platform, system, application or function, nominally operated by a service provider and situated remotely from the user platforms 102 that receives and processes user-provided text content to execute a text-based communication service or service feature. The service platform 104 is a functional element that may reside within one or more physical devices.

The network 106 comprises generally any communication medium operable to link the user platform 102 to the service platform 104. The network 106 may comprise, without limitation, an IP Multimedia Subsystem (IMS) network, a wireless network (e.g., CDMA-based, GSM-based or LTE-based network), a circuit-switched network, a packet-based network (IP network) or any other type of network.

According to embodiments of the present invention, the respective platforms 102, 104 execute a collaborative data security protocol 108 based at least in part on a user-specified privacy policy 116 when carrying out a service transaction. The user-specified privacy policy may dictate, for example, a manner of filtering or encryption of user text that dictate the amount and nature of user text that is made available to the service provider coincident to one or more service features 122; and optionally, may dictate commensurate pricing associated with one or more service features 122.

The user platform 102 and service platform 104 each include a processor and memory for effecting transactions or segments of transactions between the respective platforms, and for effecting execution of the collaborative data security protocol 108. As shown, the user platform 102 includes processor 112 and memory 114; and the service platform 104 includes processor 118 and memory 120. Generally, the processors 112, 118 are operable to execute respective program code (e.g., including but not limited to operating system firmware/software and application software) stored in the respective memory 114, 120, the execution of which depends at least in part on the user-specified privacy policy 116 and that results in performance of one or more service features 122 commensurate with the user-specified privacy policy 116.

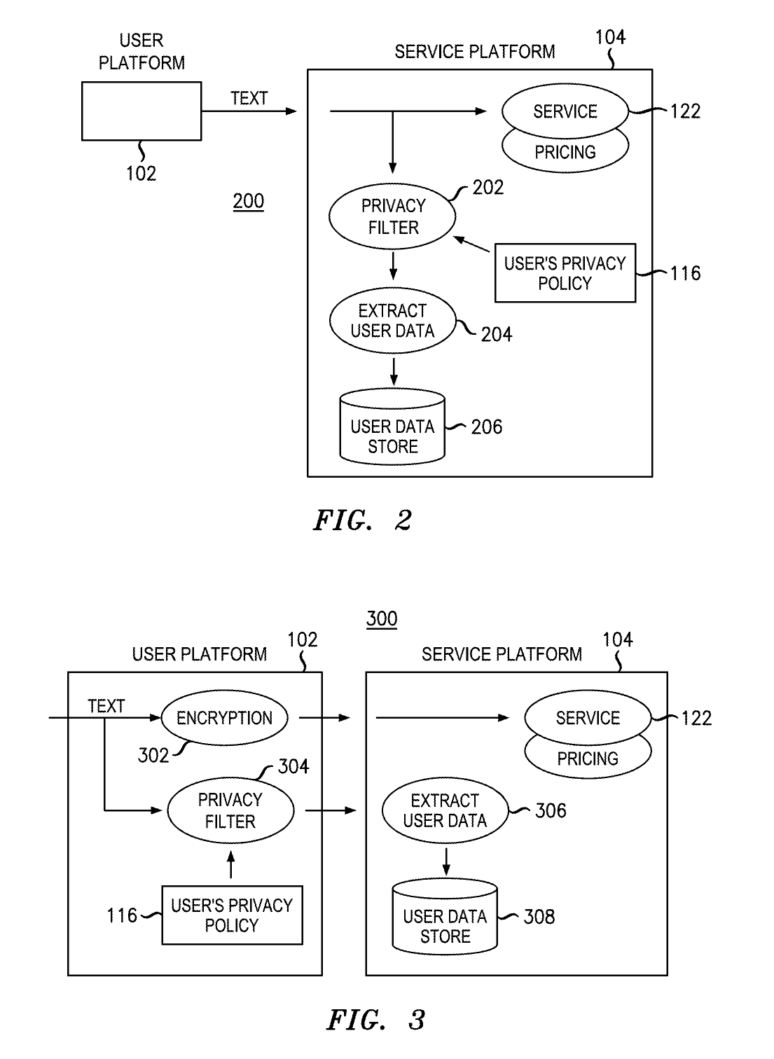

FIG. 2 depicts a first exemplary embodiment of a collaborative data security protocol 200 that may be used in the system of FIG. 1. For convenience, like elements of FIG. 2 relative to FIG. 1 will be identified with the like reference numerals.

The protocol 200 presumes that a service platform 104 receives text content (e.g., in one embodiment, unencrypted, “plain-text” content) from a user platform 102 coincident to a text-based communication service. The protocol further presumes that the service platform 104 possesses or has access to a user-specified privacy policy 116 that dictates, in one embodiment, a manner of filtering the text content. The service platform filters the text content at step 202 based on the user-specified privacy policy, yielding filtered text content. At step 204, the service platform extracts user data from the filtered text content and at step 206, stores the extracted user data. It is contemplated that the service platform at step 204 will extract a portion (e.g., certain keywords or the like) of the filtered content and store the extracted portion at step 206. Generally, however, a service provider could extract and/or store the entirety of the filtered content.

Generally, therefore, in this exemplary embodiment, the service platform receives original content (e.g., unencrypted “plain-text” content) and derives filtered text content. Accordingly, the service platform may perform one or more service features 122 using the original content and/or the filtered text content. For example, in a webmail application, the service platform may send the original content to one or more e-mail recipients; and may extract user data from the filtered text content for the basis of user-focused advertising. In one embodiment, the service provider might also price at least one aspect of the webmail service based on the user-specified privacy policy. It is contemplated, for example, the greater the filtering imposed according to the user-specified privacy policy, the lesser value of the filtered or extracted data and hence the greater the cost that will be imposed on the user, and vice versa. Depending on implementation, the pricing may be imposed on a periodic basis (e.g., monthly) or on a transactional basis.

The protocol 200 is collaborative in at least the sense that the service provider derives filtered text content based on the user-specified privacy policy rather than its own policy. However, a potential problem with the protocol 200 is that the user must trust the service provider to observe the user-specified privacy policy.

FIG. 3 depicts a second exemplary embodiment of a collaborative data security protocol 300 that may be used in the system of FIG. 1. For convenience, like elements of FIG. 3 relative to FIG. 1 will be identified with the like reference numerals.

The protocol 300 relies on the user platform 102 enforcing the privacy policy before sending any user text to the service platform. The user text is processed in two ways. First, the user platform encrypts the text content at step 302 (for example, using public key encryption) so that the service platform can not see the full user text. Second, the user platform filters the text content at step 304 based on the user-specified privacy policy 116. The two pieces—encrypted text plus filtered text—are then sent to the service platform 104. At step 306, the service platform extracts user data from the filtered text content and at step 308, stores the extracted user data.

The service platform 104 therefore receives encrypted text content and filtered text content from the user platform 102 coincident to a text-based communication service, the filtered text content having been filtered according to user-specified privacy settings. Generally, the service platform may perform one or more service features 122 using the encrypted text content and/or the filtered text content. For example, in a webmail application, the service platform may send the encrypted content to one or more e-mail recipients; and may extract user data from the filtered text content for the basis of user-focused advertising. The service provider might also price at least one aspect of the webmail service based on the user-specified privacy policy. It is contemplated, for example, the greater the filtering imposed according to the user-specified privacy policy, the lesser value of the filtered or extracted data and hence the greater the cost that will be imposed on the user, and vice versa. Depending on implementation, the pricing may be imposed on a periodic basis (e.g., monthly) or on a transactional basis.

The protocol 300 is collaborative in at least the sense that it relies on the user platform, not the service platform, to derive filtered text content. And because the service platform can not see the original user text, it is impossible for the service platform to “cheat” or extract any data in contravention of the user-specified privacy policy. However, a potential problem with the protocol 300 is that the service provider must trust the user to reveal all of what it should reveal according to the user-specified privacy policy.

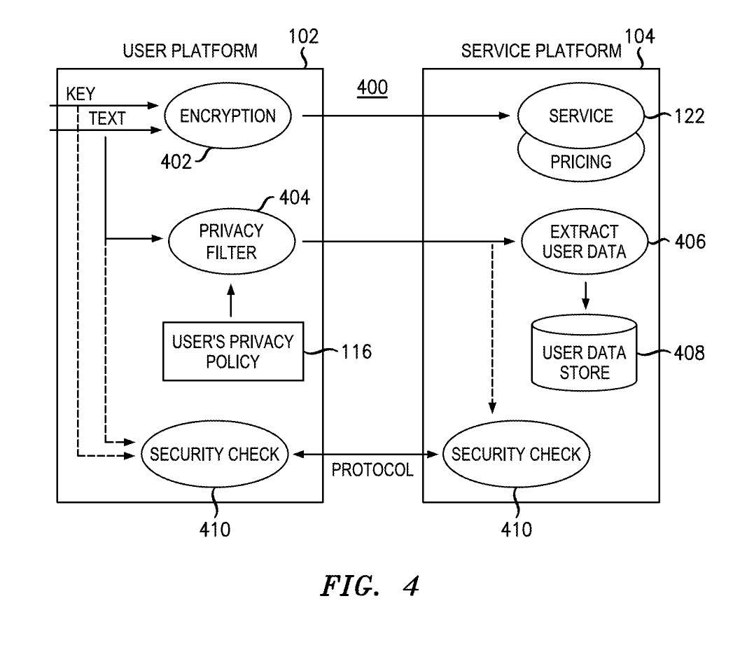

FIG. 4 depicts a third exemplary embodiment of a collaborative data security protocol 400 that may be used in the system of FIG. 1. For convenience, like elements of FIG. 4 relative to FIG. 1 will be identified with the like reference numerals.

Similarly to FIG. 3, the protocol 400 relies on the user platform 102 enforcing the privacy policy before sending any user text to the service platform. The user platform encrypts the text content at step 402 (for example, using public key encryption) so that the service platform can not see the full user text; and it filters the text content at step 404 based on the user-specified privacy policy 116. The two pieces—encrypted text plus filtered text—are then sent to the service platform 104. At step 406, the service platform extracts user data from the filtered text content and at step 408, stores the extracted user data.

The service platform 104 therefore receives encrypted text content and filtered text content from the user platform 102; and the service platform may perform one or more service features 122 using the encrypted text content and/or the filtered text content substantially as described in relation to FIG. 3. Clearly, the service platform can not cheat since it is not given the full user text. To deter the user platform from cheating, the two parties engage in a security check at step 410.

In one embodiment, the security check 410 comprises a cryptographic protocol that allows the service platform to check that the filtered text content received from the user platform corresponds to the original text content having been filtered according to the user-specified privacy policy, based in part on the encrypted text content received from the user platform and in part based on knowledge of the user-specified privacy policy 116. Advantageously, the parties will use a secure computation protocol, for example based on zero-knowledge proofs, which guarantees that no information will be revealed to the service platform other than the result of the check. In particular, the original user plaintext content will remain hidden from the service platform.

Secure computation is described in detail for example in Goldwasser, S.; Micali, S.; Rackoff, C. (1989), “The knowledge complexity of interactive proof systems”, SIAM Journal on Computing 18 (1): 186-208, doi:10.1137/0218012, ISSN 1095-7111). See also Yao's garbled circuit (cf. A. Yao. How to Generate and Exchange Secrets. In 27th FOCS, pages 162-167, 1986; and A Proof of Yao's Protocol for Secure Two-Party Computation, Yehuda Lindell and Benny Pinkas, Journal of Cryptology, 22(2):161-188, 2009).

The security check 410 need not be employed for each message transaction. It is contemplated, for example, that the security check 410 may be costly and thus it might be initiated at the request of the service platform for only a small number (for example, 1%) of randomly selected message transactions. In such embodiment, it is important that the user platform will not know in advance which messages will or will not be checked.

The present disclosure has therefore described various embodiments of a collaborative data security protocol that is collaborative in at least the sense that it relies on user-specified privacy policy settings rather than on default service provider policy settings. It is contemplated that by providing for use of user-specified privacy policy settings, greater flexibility is afforded to the user in terms of the amount or nature of content that will be revealed to (or conversely, hidden from) the service provider as a result of filtering or encryption of the original user text content. Further, it follows that providing for user-specified privacy policy settings allows for greater flexibility of pricing options and user influence on pricing options than heretofore available.

In one example, the user might select user-specified privacy policy settings or change service provider default settings coincident to ordering a particular service, establishing an account or the like and the service provider may quote a price for the service that depends on the privacy policy. Generally, for any instance of user-specified privacy policy that is selectable from among multiple options, whereby the user's choice of options dictate a different amount or nature of content that will be revealed to or hidden from the service provider, it is contemplated that the service provider may display or communicate a menu of different pricing options corresponding to the various selectable privacy options; or alternatively, the service provider may display or communicate individual price(s) corresponding to individual selected privacy options.

In one exemplary embodiment, user-specified privacy policy options allow for the following kinds of filtering: removal of proper nouns, removal of numbers, removal of words not found in an approved list, and summary statistics of the text in the form of “n-grams,” which are word sequences of length n. The first item may comprise, for example, filtering out the names of people and/or locations, such as street or city names, as well as web URLs and email addresses. The second item may comprise, for example, filtering out telephone numbers, account numbers, address numbers and the like. The third item may comprise, for example, filtering out all words except those that appear in an approved list (e.g., in one embodiment, a small “dictionary”). For instance, the user might select an instance of the third item by selecting from a small dictionary (e.g., 500 words), medium dictionary (e.g., 2000 words) or large dictionary (e.g., 10000 words), where the smaller the dictionary, the greater the privacy (and likely the greater the cost). Finally, the last option specifies that the service provider only see summary statistics of the text comprising, for example, single word counts, or counts of all three-grams (sequences of three words).

In this exemplary embodiment, therefore, the user may select one or more instances of privacy policy settings from the indicated options and communicate the selected options to the service provider via the user platform. The service provider may display or communicate a menu of different pricing options; or alternatively, may display or communicate individual price(s) corresponding to individual selected privacy options.

FIGS. 1-4 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

For example, embodiments are described herein with reference to text-based communication services comprising webmail, social networking, web search services and Instant Messaging services. However, it is to be appreciated that principles of the invention, while applicable to the exemplary text-based communication services, are not intended to be so limited. Rather, embodiments of the present invention are generally applicable to any type of communication network or hybrid network in which users provide text content to a service platform and the service platform processes the text content in some manner to execute a particular service.

Further, embodiments are described herein with reference to certain examples of user-specified privacy policy options, including removal of proper nouns, removal of numbers, removal of words not found in an approved list, and summary statistics of the text in the form of “n-grams,” which are word sequences of length n. As will be appreciated, embodiments of the invention are not limited to the particular examples but generally may be implemented using any user-specified privacy policy options that dictate some manner of filtering user text content.

What is claimed is:

1. A method of providing a text-based communication service, in accordance with a communication system including a user platform operably connected to a service platform, the method comprising the service platform:
receiving text content from the user platform;
filtering the text content according to a user-specified privacy policy, yielding filtered text content; and
performing at least one service feature using the filtered text content.

2. The method of claim 1, further comprising:
receiving indicia of the user-specified privacy policy; and
pricing at least one aspect of the text-based communication service based on the user-specified privacy policy.

3. The method of claim 1, wherein the text-based communication service comprises a webmail service, the at least one service feature comprising extracting user data from the filtered text content for the basis of user-focused advertising.

4. Apparatus for providing a text-based communication service, in accordance with a communication system including a user platform operably connected to a service platform, the apparatus at the service platform comprising:
a memory; and
at least one processor operably coupled to the memory and configured to:
(a) receive text content from the user platform;
(b) filter the text content according to a user-specified privacy policy, yielding filtered text content; and
(c) perform at least one service feature using the filtered text content.

5. The apparatus of claim 4, wherein the processor is further configured to:
receive indicia of the user-specified privacy policy; and
price at least one aspect of the text-based communication service based on the user-specified privacy policy.

6. The apparatus of claim 4, wherein the text-based communication service comprises a webmail service, and wherein the processor at part (c) is configured to extract user data from the filtered text content for the basis of user-focused advertising.

7. A method of providing a text-based communication service, in accordance with a communication system including a user platform operably connected to a service platform, the method comprising the service platform:
receiving filtered text content from the user platform, the filtered text content having been filtered from original text content according to a user-specified privacy policy; and
performing at least one service feature using the filtered text content.

8. The method of claim 7, further comprising:
receiving indicia of the user-specified privacy policy; and
pricing at least one aspect of the text-based communication service based on the user-specified privacy policy.

9. The method of claim 7, wherein the text-based communication service comprises a webmail service, the at least one service feature comprising extracting user data from the filtered text content for the basis of user-focused advertising.

10. The method of claim 7, further comprising the service platform:
receiving encrypted text content from the user platform;
receiving indicia of the user-specified privacy policy;
performing a security check based on the encrypted text content and the user-specified privacy policy to verify that the filtered text content received from the user platform corresponds to the original text content having been filtered according to the user-specified privacy policy.

11. Apparatus for providing a text-based communication service, in accordance with a communication system including a user platform operably connected to a service platform, the apparatus at the service platform comprising:
a memory; and
at least one processor operably coupled to the memory and configured to:
(a) receive filtered text content from the user platform, the filtered text content having been filtered from original text content according to a user-specified privacy policy; and
(b) perform at least one service feature using the filtered text content.

12. The apparatus of claim 11, wherein the processor is further configured to:
receive indicia of the user-specified privacy policy; and
price at least one aspect of the text-based communication service based on the user-specified privacy policy.

13. The apparatus of claim 11, wherein the text-based communication service comprises a webmail service, and wherein the processor at part (b) is configured to extract user data from the filtered text content for the basis of user-focused advertising.

14. The apparatus of claim 11, wherein the processor is further configured to:
receive encrypted text content from the user platform;
receive indicia of the user-specified privacy policy;
perform a security check based on the encrypted text content and the user-specified privacy policy to verify that the filtered text content received from the user platform corresponds to the original text content having been filtered according to the user-specified privacy policy.

15. A method of providing a text-based communication service, in accordance with a communication system including a user platform operably connected to a service platform, the method comprising the service platform:
receiving filtered text content from the user platform, the filtered text content having been filtered from original text content according to a user-specified privacy policy;
performing one or more service features using the filtered text content;
receiving indicia of the user-specified privacy policy; and
performing one or more service features based on the user-specified privacy policy.

16. The method of claim 15, wherein the text-based communication service comprises a webmail service,
the step of performing one or more service features using the filtered text content comprising extracting user data from the filtered text content for the basis of user-focused advertising;
the step of performing one or more service features based on the user-specified privacy policy comprising pricing at least one aspect of the webmail service based on the user-specified privacy policy.

17. The method of claim 15, further comprising the service platform receiving encrypted text content from the user platform;
the step of performing one or more service features based on the user-specified privacy policy comprising performing a security check based on the encrypted text content and the user-specified privacy policy to verify that the filtered text content received from the user platform corresponds to the original text content having been filtered according to the user-specified privacy policy.

18. Apparatus for providing a text-based communication service, in accordance with a communication system including a user platform operably connected to a service platform, the apparatus at the service platform comprising:
a memory; and
at least one processor operably coupled to the memory and configured to:
(a) receive filtered text content from the user platform, the filtered text content having been filtered from original text content according to a user-specified privacy policy;
(b) perform one or more service features using the filtered text content;
(c) receive indicia of the user-specified privacy policy; and
(d) perform one or more service features based on the user-specified privacy policy.

19. The apparatus of claim 18, wherein the text-based communication service comprises a webmail service, wherein
the processor at part (b) is configured to extract user data from the filtered text content for the basis of user-focused advertising; and
the processor at part (d) is configured to price at least one aspect of the webmail service based on the user-specified privacy policy.

20. The apparatus of claim 18, wherein the processor is further configured to receive encrypted text content from the user platform, and wherein
the processor at part (d) is configured to perform a security check based on the encrypted text content and the user-specified privacy policy to verify that the filtered text content received from the user platform corresponds to the original text content having been filtered according to the user-specified privacy policy.

21. A method of providing a text-based communication service, in accordance with a communication system including a user platform operably connected to a service platform, the method comprising the service platform:
receiving, from the user platform, indicia of one or more user-selected privacy policy settings, defining a user-specified privacy policy;
pricing at least one aspect of the text-based communication service based on the user-specified privacy policy; and
executing the at least one aspect of the text-based communication service based on the user-specified privacy policy.

22. The method of claim 21, wherein the step of executing comprises the service platform;
receiving text content from the user platform;
performing at least one service feature using the text content;
filtering the text content according to the user-specified privacy policy, yielding filtered text content; and
performing at least one service feature using the filtered text content.

23. The method of claim 21, wherein the step of executing comprises the service platform;
receiving encrypted text content from the user platform;
performing at least one service feature using the encrypted text content;
receiving filtered text content from the user platform, the filtered text content having been filtered from original text content according to the user-specified privacy policy; and
performing at least one service feature using the filtered text content.
